(19) United States
(12) Patent Application Publication
(10) Pub. No.: US 2021/0124006 A1
(43) Pub. Date: Apr. 29, 2021

(54) METHOD AND APPARATUS FOR ESTIMATING ANGLE OF ARRIVAL OF SIGNALS IN WIRELESS COMMUNICATION SYSTEM

(71) Applicant: HON LIN TECHNOLOGY CO., LTD., Taipei City (TW)

(72) Inventors: HUAN-TANG SHENG, Hsinchu City (TW); WEN-RONG WU, Hsinchu (TW); WEI-HAN HSIAO, Hsinchu City (TW); Mykola Servetnyk, Hsinchu City (TW)

(21) Appl. No.: 17/023,718

(22) Filed: Sep. 17, 2020

Related U.S. Application Data
(60) Provisional application No. 62/927,438, filed on Oct. 29, 2019.
(60) Provisional application No. 62/928,414, filed on Oct. 31, 2019.

(51) Int. Cl. G01S 3/10; H04L 25/02; G01S 3/28; G01S 3/74

(52) U.S. Cl. CPC G01S 3/10; H04L 25/0212; H04L 25/0224; H04B 17/364; G01S 3/28; G01S 3/74; H04L 25/0248

(57) ABSTRACT

A method for estimating angle of arrival (AoA) of signals in a wireless communication system applied in an apparatus can estimate multiple AOAs of multiple paths on one channel tap using a transmitting scheme of beamformed multiple transmissions at the transmitting side. In the transmitting scheme, the equivalent channels for paths with multiple AoAs can be viewed as random, and a subspace-based algorithm is applied for AoA estimation.

### CROSS-REFERENCE TO RELATED APPLICATION

This application claims priority to U.S. Provisional Patent Application No. 62/927,438, filed on Oct. 29, 2019, and entitled “Joint Channel and AoA Estimation for OFDM Systems with Hybrid Antenna Array: One Channel Tap with Multiple AoAs Problem”, and U.S. Provisional Patent Application No. 62/928,414, filed on Oct. 31, 2019, and entitled “JOINT CHANNEL AND AOA ESTIMATION IN OFDM SYSTEMS: ONE CHANNEL TAP WITH MULTIPLE AOAS PROBLEM”, the contents of which are incorporated by reference herein.

### FIELD

The subject matter herein generally relates to radio communications.

### BACKGROUND

Millimeter-wave (mmWave) communication is a key element in the fifth generation (5G) New Radio (NR) wireless communication system. Severe propagation losses in the mmWave channel call for massive antenna array to conduct beamforming, thus a receiver has to know angle of arrival (AoA) information.

In indoor environments, transmitted signals may propagate through multiple paths resulting in close time delays, which are not resolvable, this is the problem of one channel tap with multiple AoAs (OCMA).

Thus, there is room for improvement within the art.

### BRIEF DESCRIPTION OF THE DRAWINGS

Implementations of the present technology will now be described, by way of embodiment, with reference to the attached figures, wherein:

FIG. 1 is a block diagram of one embodiment of an apparatus for estimating the angle of arrival of the signal.

FIG. 2 is a schematic block diagram of one embodiment of an antenna array of the apparatus of FIG. 1.

FIG. 3 is an example of one embodiment of a channel delay profile obtained by the apparatus of FIG. 1.

FIG. 4 is an example of one embodiment of a transmitting scheme at the transmitting side.

FIG. 5 is a flowchart of one embodiment of a method for estimating the angle of arrival.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

References to “an” or “one” embodiment in this disclosure are not necessarily to the same embodiment, and such references mean “at least one”.

In general, the word “module” as used hereinafter, refers to logic embodied in computing or firmware, or to a collection of software instructions, written in a programming language, such as Java, C, or assembly. One or more software instructions in the modules may be embedded in firmware, such as in an erasable programmable read-only memory (EPROM). The modules described herein may be implemented as either software and/or computing modules and may be stored in any type of non-transitory computer-readable medium or another storage device. Some non-limiting examples of non-transitory computer-readable media include CDs, DVDs, BLU-RAY, flash memory, and hard disk drives. The term “comprising”, when utilized, means “including, but not necessarily limited to”; it specifically indicates open-ended inclusion or membership in a so-described combination, group, series, and the like.

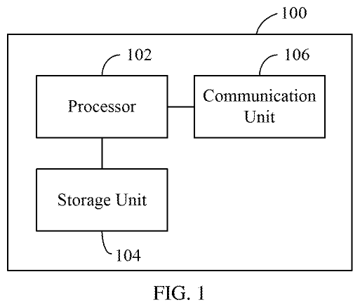

FIG. 1 illustrates a block diagram of an apparatus 100 for estimating an angle of arrival (AoA) of signals according to one embodiment. The apparatus 100 acts with a User Equipment (UE), a base station, and a wireless transmitting/receiving unit (WTRU). The apparatus 100 comprises a processor 102, a storage unit 104, and a communication unit 106.

The processor 102 controlling the apparatus 100 comprises a microcontroller, a microprocessor, or another circuit with processing capabilities, and executes or processes instructions, data, and computer programs stored in the storage unit 104.

The storage unit 104 comprises a read-only memory (ROM), a random access memory (RAM), a magnetic disk storage medium device, an optical storage medium device, a flash memory device, electrical, optical, or other physical/tangible (e.g., non-transitory) memory device, etc. The storage unit 104 is used to store one or more computer programs that control the operation of the apparatus 100 and which are executed by the processor 102. In the embodiment, the storage unit 104 stores or encodes one or more computer programs, and stores models, configurations, and computing parameters data, for the processor 102, to execute a method for estimating AOA according to various embodiments.

The communication unit 106 performs functions for transmitting and receiving signals through a wireless channel. The communication unit 106 comprises a transmission filter, a reception filter, an amplifier, a mixer, an oscillator, a digital-to-analog converter (DAC), and an analog-to-digital converter (ADC). The communication unit 106 may comprise multiple transmission/reception paths. Further, the communication unit 106 may comprise an antenna array comprising a plurality of antenna elements.

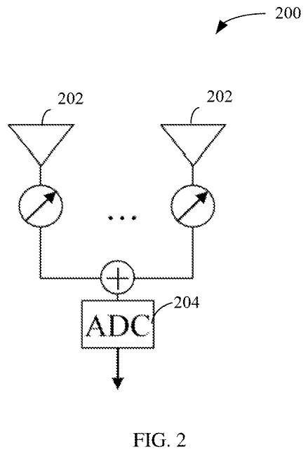

FIG. 2 illustrates a block diagram of an antenna array 200 of the communication unit 106 according to one embodiment. The antenna array 200 comprises My antennas 202 and one ADC 204. The signals received at each antenna 202 are first phase-shifted, i.e., multiplied by the phase-shifter coefficient, and then summed up as the input of the ADC 204.

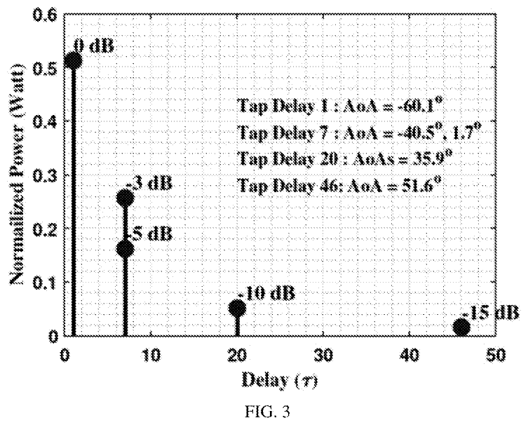

FIG. 3 illustrates an example of a channel delay profile of the antenna array 200 with M_{γ}=4 antennas in a MIMO-OFDM system. The channel delay profile exists for every channel and link, respectively, formed by each beam arrangement between the receiving side and the transmitting side and indicates the intensity of a signal received through a multipath channel as a function of time delay. As FIG. 3 shows, at Tap Delay 7, there are two taps with two different AoAs. This is the OCMA problem for the tap at Tap Delay 7. Various embodiments on AoA estimation for the tap with the OCMA problem in a wireless communication system are disclosed.

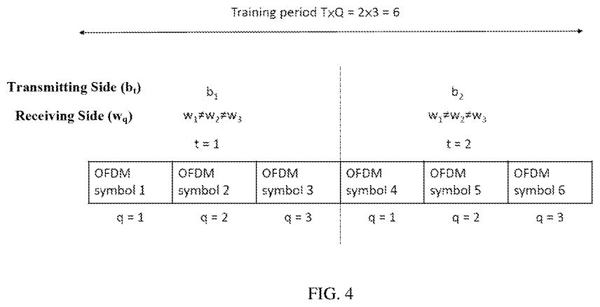

In one embodiment, Q consecutive OFDM symbols are transmitted at the transmitting side in a MIMO-OFDM system as training symbols for channel estimation. The transmission of Q consecutive OFDM symbols is referred to as a training block. In order to resolve the OCMA problem, FIG. 4 illustrates an example of a transmitting scheme of transmitting training blocks with different transmitting beamforming vectors such that different paths experience different transmit beamforming gains. Let t be the index of each training block, and T be the number of training blocks, then the total number of OFDM symbols for the estimation is T×Q. As shown in FIG. 4, the transmitting beamforming vectors b₁, b₂ are different for different training blocks, but bₜ remains the same within each training block. The w_{q}, denoting the receiving beamforming vectors, varies within each block.

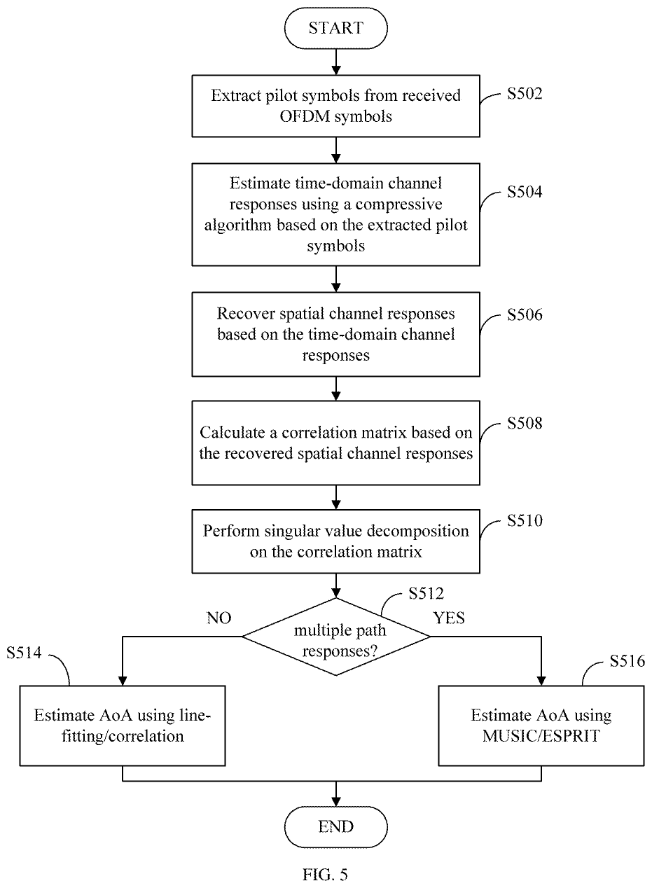

FIG. 5 illustrates a method for estimating AoA performed by the apparatus 100 at the receiving side according to one embodiment.

In the embodiment, the method for estimating AoA comprises three stages. The first stage is to estimate the time-domain channel impulse response for each channel tap. The second stage uses different transmitting beamforming vectors with different receiving beamforming vectors to decouple the channel responses for each antenna element of the antenna array 200. The third stage is to calculate the correlation matrix and use a subspace-based algorithm such as Multiple Signal Classification (MUSIC), Estimation of Signal Parameters via Rotational Invariance Techniques (ESPRIT) to estimate multiple AoAs.

The detailed steps of the method are shown in FIG. 5.

In order to remove distortion from the received input signals, the effects of the channels need to be estimated. In one embodiment, the channel estimation is implemented using pilot symbols. The pilot symbols may be transmitted by the transmitting side in the OFDM symbols at certain subcarriers. The pilot symbols have known values for both the transmitting side and the receiving side, thus the channel can be estimated using the pilot symbols.

At step S502, the apparatus 100 extracts pilot symbols from the received OFDM symbols. The extracted pilot symbols \tilde{x}₁, . . . , \tilde{x}_{P}, are expressed as a diagonal matrix \tilde{X}=diag{\tilde{x}₁, . . . , \tilde{x}_{P}}. The partial Discrete Fourier Transform (DFT) matrix of size P×L, where L is the length of the cyclic prefix (CP), is denoted as F. Then the noiseless frequency-domain received signal at P pilot-subcarriers, beamformed by the hybrid antenna array of the apparatus 100, at the q-th received OFDM symbol can be expressed as:

\tilde{r}(q)=\tilde{F}h_{c}(q)∈ [symbol] ^{P×1} (1)

where \tilde{F}=\tilde{X}F, and h_{c}(q) is the spare beamformed time-domain channel impulse response (CIR) vector with I (I«L) non-zero entries at the q-th received OFDM symbol.

At step S504, the apparatus 100 estimates the time-domain CIR vector using a compressive sensing algorithm based on the extracted pilot symbols. In one embodiment, the apparatus 100 uses an extended subspace pursuit algorithm, which exploits the property that h_{c}(q)'s share the same tap delay.

At step S506, the apparatus 100 recovers spatial channel responses based on the time-domain CIR vector.

In one embodiment, h_{c}(q) can be expressed as a linear combination of CIRs for all antennas:

h_{c}(q)=Σₘ₌₁^{M}^{ᵣ}w_{m,q}hₘ (2)

where hₘ is the CIR for the m-th antenna. Next, for a matrix as the collection of h_{c}(q)'s as

$$\begin{matrix}{H}_{c} {=}^{Δ} [ {h}_{c} ( 1 ) … {h}_{c} ( Q ) ] \\ = [ {h}_{1} … {h}_{{M}_{r}} ] [ \begin{matrix}{w}_{1 , 1} & ⋯ & {w}_{1 , Q} \\ ⋮ & ⋱ & ⋮ \\ {w}_{{M}_{r} , 1} & ⋯ & {w}_{{M}_{r , Q}}\end{matrix} ] \\ {=}^{Δ} HW\end{matrix} \qquad ( 3 )$$

where W is defined as the receiving beamforming matrix. Thus, H can be obtained as H=H_{c}W^{†}, where (.)^{†} represents the pseudo-inverse of a square or over-determined matrix, indicating that W must be of full row rank (Q≥M_{γ}).

In one embodiment, with multiple transmissions at the transmitting side, the measurements lost in the spatial domain can be compensated for by those obtained in the time domain. In this embodiment, each channel tap is flat fading, and W is designed as a unitary or semi-unitary matrix to avoid amplification of noise.

At step S508, for each channel tap delay, the apparatus 100 calculates a correlation matrix based on the recovered spatial channel responses.

In one embodiment, the tap delay of the i-th path is referred to as Tᵢ, and the Tᵢ-th row of H is referred to as yᵢ^{T}. To estimate the AoA of the i-th path, denoted as θᵢ, the apparatus 100 uses yᵢ, which is the corresponding channel estimation vector:

$$\begin{matrix}{y}_{i} = {h}_{i} [ \begin{matrix}1 \\ ⋮ \\ {e}^{- j π ( {M}_{r} - 1 ) sin {θ}_{i}}\end{matrix} ] \\ = {h}_{i} a ( {θ}_{i} )\end{matrix} \qquad ( 4 )$$

where a(θᵢ) is the steering vector for the i-th path. From (4), the (θᵢ) can be obtained by a simple correlation-based method, given by

$$\begin{matrix}{\hat{∅}}_{i , Cor} {=}^{Δ} - π sin ( {\hat{θ}}_{i , Cor} ) \\ = ∡ [ \frac{1}{{M}_{r} - 1} {\sum }_{m = 2}^{{M}_{r}} {y}_{i} ( m ) {y}_{i}^{*} ( m - 1 ) ]\end{matrix} \qquad ( 5 )$$

where \hat{Ø}_{i,Cor} is the phase difference of two consecutive elements in the steering vector, \hat{θ}_{i,Cor} is the estimated AoA, [symbol] [.] and (.)* are the complex conjugate of a scalar.

In some situations, some channel taps may contain responses of two paths or more. To address this problem, (4) can be re-written as

$$\begin{matrix}{y}_{i} = {\sum }_{k = 1}^{{K}_{i}} {h}_{i , k} [ \begin{matrix}1 \\ ⋮ \\ {e}^{- j π ( {M}_{r} - 1 ) sin {θ}_{i}}\end{matrix} ] \\ = [ a ( {θ}_{i , 1} ) … a ( {θ}_{i , {K}_{i}} ) ] [ \begin{matrix}{h}_{i , 1} \\ ⋮ \\ {h}_{i , {K}_{i}}\end{matrix} ] \\ {=}^{Δ} {Ah}_{( i )}\end{matrix} \qquad ( 6 )$$

where Kᵢ is the total number of channel impulse responses corresponding to different paths sampled by i-th channel tap delay, and h₍ᵢ₎ is a Kᵢ-by-1 vector consisting of the channel gains of the i-th channel tap delay. In one embodiment, allowing for channel estimation error, the apparatus 100 can be modeled as;

ŷ=yᵢ+eᵢ (7)

where eᵢ is the channel estimation error vector, which is non-white in general.

To resolve the OCMA problem, the apparatus 100 notifies the transmitting side to transmit training blocks with different transmitting beamforming vectors such that different channel paths will experience different channel gains. As illustrated in FIG. 4, the transmitting beamforming vector b(t) of the transmitting side remains the same for each training block, and the receiving beamforming vector w(q) varies in each training block. Letting h₍ᵢ₎(t) be the Kᵢ-by-1 channel gain vector for the i-th channel tap at the t-th transmission training block, and h₍ᵢ₎ (t) be variant for the T blocks. The apparatus 100 can calculate the correlation matrix as;

$$\begin{matrix}{R}_{{\hat{y}}_{i}} {=}^{Δ} \frac{1}{T} {\sum }_{t = 1}^{T} {\hat{y}}_{i} ( t ) {\hat{y}}_{i}^{H} ( t ) \\ = {AR}_{{h}_{( i )}} {A}^{H} + {R}_{{\hat{e}}_{i}}\end{matrix} \qquad ( 8 )$$

where

$${R}_{{h}_{( i )}} = \frac{1}{T} {\sum }_{t = 1}^{T} {h}_{( i )} ( t ) {h}_{( i )}^{T} ( t ) ,$$

and R_{ê}_{ᵢ} is the matrix formed by error vectors. Rank(Rₕ_{₍ᵢ₎})=Kᵢ, meaning that T≥Kᵢ.

At step S510, the apparatus 100 performs singular value decomposition on the correlation matrix.

At step S512 the apparatus 100 determines whether a channel tap having multiple channel responses is caused by multiple signal paths. When the apparatus 100 determines that the number of path responses on the channel tap is equal to one, the apparatus 100 executes step S514, and when the apparatus determines that the number of path responses on the channel tap is more than one, the apparatus executes step S516.

At step S514, the apparatus 100 estimates AoA of the one path response using a line-fitting or correlation algorithm.

At step S516, the apparatus 100 estimates multiple AoAs of the multiple path responses using a subspace-based algorithm, such as MUSIC or ESPRIT.

In one embodiment, the apparatus 100 performs singular value decomposition on R_{ŷ}_{ᵢ}=ARₕ_{₍ᵢ₎}A^{H}, and obtains

$${R}_{{y}_{i}} = [ {U}_{S} {U}_{O} ] [ \begin{matrix}{Σ}_{S} & 0 \\ 0 & 0\end{matrix} ] [ \begin{matrix}{U}_{S}^{H} \\ {U}_{O}^{H}\end{matrix} ] \qquad ( 9 )$$

where τₛ∈ [symbol] ^{K}^{ᵢ}^{×K}^{ᵢ} is a diagonal matrix with non-zero diagonal entries in descending order, and U_{S} ∈ [symbol] ^{M}^{ᵣ}^{×K}^{ᵢ} is the matrix spanning the same column space as A, while U_{O} is its orthogonal complement, i.e., span(A)=span(U_{S}) ⊥span(U_{O}).

Then, the MUSIC algorithm uses the orthogonal subspace U_{O} to find multiple AoAs by searching for the peaks of the function defined as

$$f ( θ ) {=}^{Δ} \frac{1}{{‖ {a}^{H} ( θ ) {\hat{U}}_{O} ‖}_{2}^{2}} \qquad ( 10 )$$

where Û_{O} is the estimation of orthogonal subspace due to the presence of additive error in (7). Since the signal-to-noise ratio (SNR) of the channel estimation is much higher than that of the received signal for the antennas (due to the fact P»I), the non-white property of the error is not apparent. In this embodiment, Mᵣ should be larger than K to render the orthogonal subspace non-empty.

In one embodiment, span(A)=span(U_{S}), hence there exists a unique and invertible matrix P such that AP=U_{S}. Although P is unknown, U_{S} can be used to find θ_{i,1}, . . . , θ_{i,K} as follows:

$$AP = {U}_{S} \\ ⇔ [ \begin{matrix}{A}_{odd} P \\ {A}_{even} P\end{matrix} ] = [ \begin{matrix}{U}_{s , odd} \\ {U}_{s , even}\end{matrix} ] \\ ⇔ [ \begin{matrix}{A}_{odd} P \\ {A}_{odd} ϕ P\end{matrix} ] = [ \begin{matrix}{U}_{s , odd} \\ {U}_{s , even}\end{matrix} ] \qquad ( 11 )$$

where ϕ=diag{e^{-jπ sin θ}^{_{i,1}}, . . . ,e^{-jπ(M}^{ᵣ}^{-1)sin θ}_{i,Ki}}, (.)_{odd} denotes the sub-matrix consisting of the odd rows of the matrix, and (.)ₑᵥₑₙ denotes the sub-matrix consisting of the even rows of the matrix. By rearranging (11), obtain:

U_{s,even}=U_{s,odd}P⁻¹ϕP (12)

Mᵣ/2≥Kᵢ, P⁻¹ϕP can be obtained by the least-squares or total-least-squares methods. It is shown that ϕ is a diagonal matrix containing the eigenvalues of P⁻¹ϕP. After ϕ is obtained, the multiple AoAs, θ_{i,1}, . . . , θ_{i,K}_{ᵢ}, can be derived easily.

The AoA estimation method and apparatus of the present disclosure resolve the OCMA problem with a hybrid antenna array. Conventional subspace based algorithms such as MUSIC and ESPRIT can be applied, and the number of AoAs that can be estimated by the method and the apparatus is not limited by the number of antennas.

The embodiments shown and described above are only examples. Many details are often found in the art, therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will, therefore, be appreciated that the embodiments described above may be modified within the scope of the claims.

What is claimed is:

1. A method for estimating angle of arrival of signals in a wireless communication system include a transmitting side and a receiving side, the method comprising:
receiving, by the receiving side, a plurality of signals transmitted by the transmitting side;
extracting, by the receiving side, a plurality of pilot symbols from the received signals;
estimating, by the receiving side, time-domain channel responses using a compressive sensing algorithm based on the extracted pilot symbols;
recovering, by the receiving side, spatial channel responses based on the estimated time-domain channel responses;
obtaining, by the receiving side, a plurality of channel taps based on the recovered spatial channel responses;
calculating, by the receiving side, a correlation matrix, for each one of the plurality of channel taps, based on the recovered spatial channel responses;
performing, by the receiving side, singular value decomposition on the correlation matrix for each one of the plurality of channel taps to obtain a singular value representation of the correlation matrix;
determining, by the receiving side, a number of responses caused by different paths for each one of the plurality of channel taps; and
estimating, by the receiving side, angle of arrival, for each one of the plurality of channel taps, based on the determined number of responses and the singular value representation of the correlation matrix.

2. The method of claim 1, the step of estimating angle of arrival, by the receiving side, for each one of the plurality of channel taps, based on the determined number of responses and the singular value representation of the correlation matrix, further comprises:
estimating angle of arrival using a line-fitting algorithm when the determined number is equal to one.

3. The method of claim 1, the step of estimating angle of arrival, by the receiving side, for each one of the plurality of channel taps, based on the determined number of responses and the singular value representation of the correlation matrix, further comprises:
estimating angle of arrival using a subspace-based algorithm when the determined number of channel responses is larger than one.

4. The method of claim 3, wherein the subspace-based algorithm further comprises: a Multiple Signal Classification (MUSIC) algorithm and a Estimation of Signal Parameters via Rotational Invariance Techniques (ESPRIT) algorithm.

5. The method of claim 1, wherein the transmitting side and the receiving side are each comprised of multiple antennas in a multiple-input and multiple-output (MIMO) wireless communication system.

6. The method of claim 5, wherein the multiple antennas of the receiving side further comprise a hybrid antenna array.

7. The method of claim 1, wherein the plurality of signals transmitted by the transmitting side further comprises a plurality of training blocks and each one of the plurality of training block comprises a plurality of consecutive Orthogonal Frequency Division Multiplexing (OFDM) symbols.

8. The method of claim 7, wherein the plurality of training blocks are transmitted by the transmitting side using different transmitting beamforming vectors.

9. The method of claim 7, wherein the plurality of consecutive OFDM symbols of one of the plurality of training blocks are received by the receiving side using different receiving beamforming vectors.

10. An apparatus for estimating angle of arrival of signals, working as a receiving side, in a wireless communication system, wherein the wireless communication system further comprises a transmitting side, the apparatus comprising:
a communication unit;
a processor; and
a storage unit for storing at least one computer program, wherein the at least one computer program comprises instructions which are executed by the processor, and performs a method comprising:
receiving, by the communication unit, a plurality of signals transmitted by the transmitting side;
extracting a plurality of pilot symbols from the received signals;
estimating time-domain channel responses using a compressive sensing algorithm based on the extracted pilot symbols;
recovering spatial channel responses based on the estimated time-domain channel responses;
obtaining a plurality of channel taps based on the recovered spatial channel responses;
calculating a correlation matrix, for each one of the plurality of channel taps, based on the recovered spatial channel responses;
performing singular value decomposition on the correlation matrix, for each one of the plurality of channel taps, to obtain a singular value representation of the correlation matrix;
determining a number of responses caused by different paths for each one of the plurality of channel taps; and
estimating angle of arrival, for each one of the plurality of channel taps, based on the determined number of responses and the singular value representation of the correlation matrix.

11. The apparatus of claim 10, the step of estimating angle of arrival, for each one of the plurality of channel taps, based on the determined number of responses and the singular value representation of the correlation matrix, further comprises:
estimating angle of arrival using a line-fitting algorithm when the determined number is equal to one.

12. The apparatus of claim 10, the step of estimating angle of arrival, for each one of the plurality of channel taps, based on the determined number of responses and the singular value representation of the correlation matrix, further comprises:
estimating angle of arrival using a subspace-based algorithm when the determined number of channel responses is larger than one.

13. The apparatus of claim 12, wherein the subspace-based algorithm further comprises: a Multiple Signal Classification (MUSIC) algorithm and a Estimation of Signal Parameters via Rotational Invariance Techniques (ESPRIT) algorithm.

14. The apparatus of claim 10, wherein the communication unit and the transmitting are each comprised of multiple antennas in a multiple-input and multiple-output (MIMO) wireless communication system.

15. The apparatus of claim 14, wherein the multiple antennas of the communication unit further comprise a hybrid antenna array.

16. The apparatus of claim 10, wherein the plurality of signals transmitted by the transmitting side further comprises a plurality of training blocks and each one of the plurality of training block comprises a plurality of consecutive Orthogonal Frequency Division Multiplexing (OFDM) symbols.

17. The apparatus of claim 16, wherein the plurality of training blocks are transmitted by the transmitting side using different transmitting beamforming vectors.

18. The apparatus of claim 16, wherein the plurality of consecutive OFDM symbols of one of the plurality of training blocks are received by the communication unit using different receiving beamforming vectors.
